(19) United States
(12) Patent Application Publication
(10) Pub. No.: US 2010/0259629 A1
(43) Pub. Date: Oct. 14, 2010

(54) CAMERA DEVICE FOR CAPTURING HIGH-RESOLUTION IMAGE BY USING LOW-PIXEL-NUMBER PHOTO SENSING ELEMENT

(75) Inventor: Jui-Hsiang Lo, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/483,991

(22) Filed: Jun. 12, 2009

(30) Foreign Application Priority Data
Apr. 10, 2009 (TW) 098111993

(51) Int. Cl. H04N 5/228; H04N 5/225

(52) U.S. Cl. 348/222.1; 348/335; 348/E05.031

(57) ABSTRACT

A camera device includes a lens module, a photo sensing element and a micro-electro-mechanical system mirror. The lens module is used for receiving an external light beam. The photo sensing element includes at least one pixel sensor with a first pixel number. The micro-electro-mechanical system mirror is used for reflecting the external light beam to the photo sensing element, thereby obtaining a digital image with a second pixel number. The micro-electro-mechanical system mirror is swung at different angles to receive the external light beam with different incidence angles, so that the second pixel number is higher than the first pixel number.

### FIELD OF THE INVENTION

The present invention relates to a camera device, and more particularly to a camera device for capturing a high-resolution image by using a low-pixel-number photo sensing element.

### BACKGROUND OF THE INVENTION

Recently, the demand on the resolution of a digital device becomes more stringent. Since the general trends in designing a digital device are toward small size, light weightiness and easy portability, the pixel area of the photo sensing element of the digital device is gradually reduced. As known, a smaller pixel has less light-gathering area, which means the light signal is usually insufficient and the sensitivity is deteriorated. The common photo sensing element includes, for example, a CCD (charge coupled device) chip or a CMOS (complementary metal-oxide semiconductor) chip. For increasing the resolution of the digital device, a high-pixel-number photo sensing element has been disclosed. The high-pixel-number photo sensing element is usually very costly. As the pixel number of the image sensor is increased but the volume of the digital device is limited, the light-gathering area of each pixel is very small and the light exposure amount is usually insufficient. In other words, it is complicated and costly to increase the sensitivity of the image sensor while reducing the volume thereof.

Therefore, there is a need of providing an improved camera device so as to obviate the drawbacks encountered from the prior art.

### SUMMARY OF THE INVENTION

It is an object of the present invention to provide a camera device having an image sensor with high resolution, low area and sufficient light exposure amount without largely increasing the fabricating cost of the camera device.

In accordance with an aspect of the present invention, there is provided a camera device. The camera device includes a lens module, a photo sensing element and a micro-electro-mechanical system mirror. The lens module is used for receiving an external light beam. The photo sensing element includes at least one pixel sensor with a first pixel number. The micro-electro-mechanical system mirror is used for reflecting the external light beam to the photo sensing element, thereby obtaining a digital image with a second pixel number. The micro-electro-mechanical system mirror is swung at different angles to receive the external light beam with different incidence angles, so that the second pixel number is higher than the first pixel number.

In an embodiment, the micro-electro-mechanical system mirror includes a first rotating shaft, so that the micro-electro-mechanical system mirror is permitted to swing in a one-dimensional direction. The photo sensing element is a linear photo sensing element.

In an embodiment, the micro-electro-mechanical system mirror further includes a second rotating shaft, so that the micro-electro-mechanical system mirror is permitted to swing in a two-dimensional direction. Preferably, the at least one pixel sensor is a photo diode. Alternatively, the at least one pixel sensor includes multiple pixel sensors, which are arranged in a two-dimensional array.

The camera device of the present invention can be directly used as a camera or applied to a camera module of a hand-held electronic device.

In an embodiment, the external light beam is transmitted along an optical path to the photo sensing element through the lens module and the micro-electro-mechanical system mirror. The camera device further includes a light-shielding structure for enclosing the optical path, thereby preventing other light beam from entering the photo sensing element.

In accordance with another aspect of the present invention, there is provided an image capturing system for processing an image of an object within a shooting region into a digital image. The image capturing system includes a lens module, a photo sensing element, a reflective mirror and a processor. The lens module is used for receiving a light beam from the object. The photo sensing element includes multiple pixel sensors, which are arranged in a two-dimensional array, for receiving the light beam and converting the light beam into an electronic signal. An object region allowed to be processed during a single exposure duration of the photo sensing element is smaller than the shooting region. The reflective mirror is rotated in a two-dimensional direction for successively projecting the image of the object onto the photo sensing element by multiple times, so that the image of the object is converted into multiple digital sub-images. The processor is used for combining the multiple digital sub-images as the digital image.

In an embodiment, the reflective mirror is a micro-electro-mechanical system mirror. The reflective mirror includes two rotating shafts, so that the reflective mirror is permitted to swing in a two-dimensional direction.

In an embodiment, the image capturing system further includes a casing for accommodating the lens module, the photo sensing element and the reflective mirror.

In an embodiment, the task of combining the digital sub-images could be implemented by a processor within the casing. The image capturing system further includes a data storage device for storing the digital image, and a memory for temporarily storing the multiple digital sub-images.

In an embodiment, the data storage device is removable from the casing.

In an embodiment, the task of combining the digital sub-images could be implemented by a central processing unit of a personal computer.

Generally, the exposure action of the photo sensing element is implemented by an electronic shutter. In an embodiment, the image capturing system further includes a shutter arranged between the lens module and the photo sensing element. The light exposure duration of the photo sensing element is adjustable by controlling the open or close status of the shutter. The multiple digital sub-images are formed during each cycle of opening and closing the shutter.

In accordance with a further aspect of the present invention, there is provided a camera module of a hand-held electronic device. The camera module includes at least one photo diode pixel sensor, a a first lens for receiving an external light beam, and a micro-electro-mechanical system mirror for reflecting the external light beam to the at least one photo diode pixel sensor. The micro-electro-mechanical system mirror is swung at different angles so as to form a digital image.

In an embodiment, the micro-electro-mechanical system mirror includes two rotating shafts rotated in two different directions, so that the micro-electro-mechanical system mirror is permitted to swing in a two-dimensional direction. The at least one photo diode pixel sensor includes a single photo diode. Alternatively, the at least one photo diode pixel sensor includes multiple photo diodes, which are formed on a chip and arranged in a two-dimensional array.

In an embodiment, the at least one photo diode pixel sensor includes multiple photo diodes arranged in a line, and the micro-electro-mechanical system mirror includes a rotating shaft, so that the micro-electro-mechanical system mirror is permitted to swing in a one-dimensional direction.

In an embodiment, the camera module further includes a second lens arranged between the micro-electro-mechanical system mirror and the at least one photo diode pixel sensor for adjusting the external light beam that is reflected by the micro-electro-mechanical system mirror.

In an embodiment, the camera module further includes a printed circuit board and a lens holder. The at least one photo diode pixel sensor is fixed on the printed circuit board. The lens holder is mounted on the printed circuit board for fixing the second lens.

In an embodiment, the camera module further includes a casing for enclosing and fixing the first lens, the micro-electro-mechanical system mirror and the printed circuit board.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a camera device for capturing a high-resolution digital image by using a low-pixel-number photo sensing element according to an embodiment of the present invention;

FIG. 2 is a schematic perspective view illustrating the detailed structure of an exemplary micro-electro-mechanical system mirror used in the camera device of the present invention;

FIG. 3 is a schematic perspective view illustrating the detailed structure of another exemplary micro-electro-mechanical system mirror used in the camera device of the present invention;

FIG. 4 is a schematic view illustrating an optical imaging path of the camera device shown in FIG. 1;

FIG. 5 is a schematic view illustrating an optical imaging path according to a second embodiment of the present invention;

FIG. 6 is a schematic view illustrating an optical imaging path according to a third embodiment of the present invention;

FIG. 7 is a schematic cross-sectional view illustrating a camera module of a hand-held electronic device;

FIG. 8 is a schematic functional block diagram illustrating an image capturing system for capturing and combining digital sub-images according to the present invention; and

FIG. 9 is a schematic view illustrating a digital image obtained by the image capturing system of the present invention.

### DETAILED DESCRIPTION OF THE PREFERRED EMBODIMENT

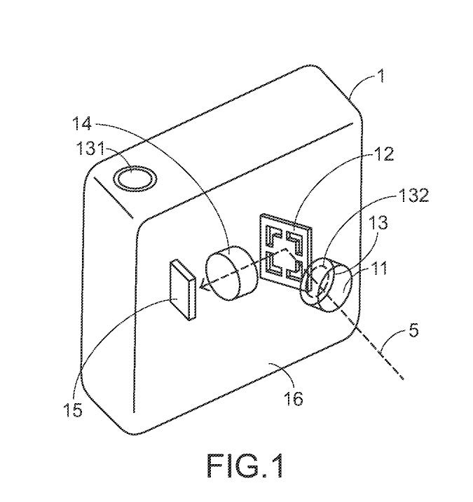

FIG. 1 is a schematic view illustrating a camera device for capturing a high-resolution digital image by using a low-pixel-number photo sensing element according to an embodiment of the present invention. As shown in FIG. 1, the camera device 1 includes a lens module 11, a MEMS (micro-electro-mechanical system) mirror 12, a shutter 13, a projection lens 14, a photo sensing element 15 and a casing 16. Once a button 131 of the shutter 13 is depressed, an external light beam 5 is introduced into the internal portion of the camera device 1 through the lens module 11, and then directed to the MEMS mirror 12. The light beam 5 is reflected by the MEMS mirror 12 and then projected onto the photo sensing element 15 through the projection lens 14. By the photo sensing element 15, the light beam 5 is converted into an electronic signal so as to obtain a digital image. Moreover, the MEMS mirror 12 is permitted to swing in two dimensions. During the swinging process of the MEMS mirror 12, the photo sensing element 15 performs several image-capturing operations. As a consequence, the digital image obtained by the camera device 1 has a higher pixel number than the photo sensing element 15.

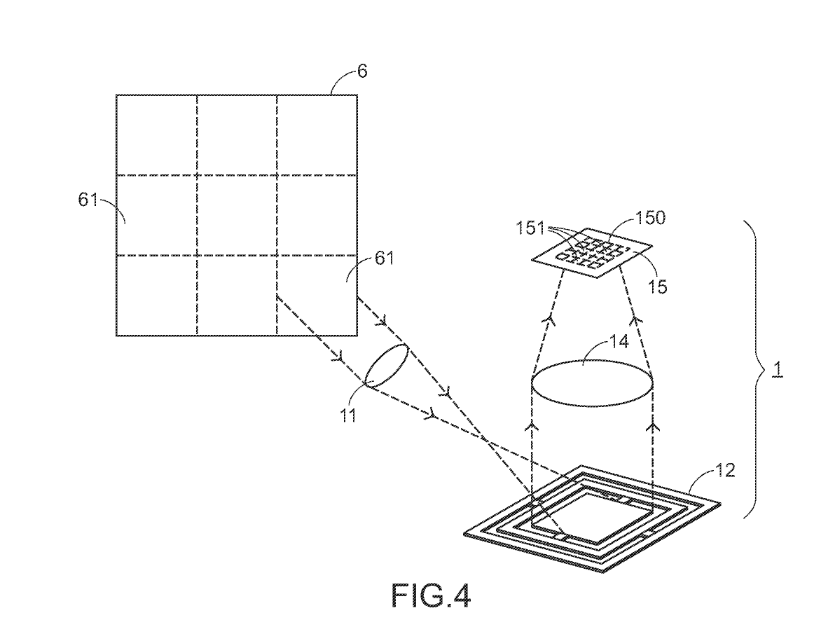

FIG. 4 is a schematic view illustrating an optical imaging path of the camera device shown in FIG. 1. As shown in FIG. 4, an example of the photo sensing element 15 includes but is not limited to a CCD (charge coupled device) chip or a CMOS (complementary metal-oxide semiconductor) chip. The photo sensing element 15 has multiple pixel sensors 151, which are arranged in a two-dimensional array 150. Please refer to FIG. 1 again. After the button 131 of the shutter 13, a single exposure action of the photo sensing element 15 is implemented during a cycle of opening and closing the opening 132 of the shutter 13. In a case that the photo sensing element 15 is a CMOS chip or a CCD chip, the shutter 13 is replaced by an electronic shutter. During the single exposure duration, electric charges generated by the photo sensing element 15 and based on the photoelectric effect are transmitted to and stored in a charge storage device (not shown) when an external voltage is applied thereto. Since the intensities of the light beams received by the pixel sensors 151 are different, the intensities of the electric charge signals stored in different charge storage devices are distinguished. These electric charge signals are then converted into a digital image. Conventionally, since a digital image is obtained during the single exposure duration of a CMOS chip or a CCD chip, the resolution of the digital image is dependent on the number of pixel sensors included in the CMOS chip or the CCD chip. According to the present invention, the MEMS mirror 12 is swung at different angles and the photo sensing element 15 is subject to a multiple exposure process, thereby obtaining a digital image having higher pixel number than the low-pixel-number photo sensing element 15. Take a CMOS chip having 300 thousand pixels as the photo sensing element 15 for example. Once the button 131 of the shutter 13 is depressed, the MEMS mirror 12 is swung at nine different angles at nine different time spots. For nine single exposure actions, nine digital sub-images having 300 thousand pixels are obtained. After these nine digital sub-images are combined together, a digital image having 2.7 million pixels is obtained. The nine different swinging angles of the MEMS mirror 12 and the nine different time spots should be elaborated controlled in order to successfully combine the nine low-pixel-number digital sub-images as the high-pixel-number digital image. In other words, the 2.7 million pixel digital device is obtainable by using the 300 thousand pixel photo sensing element. Although the 300 thousand pixel photo sensing element has only one ninth of light-gathering area of the 2.7 million pixel photo sensing element, the digital image having 2.7 million pixels is obtained. As a consequence, the resolution of the digital device is increased while maintaining the small-sized appearance.

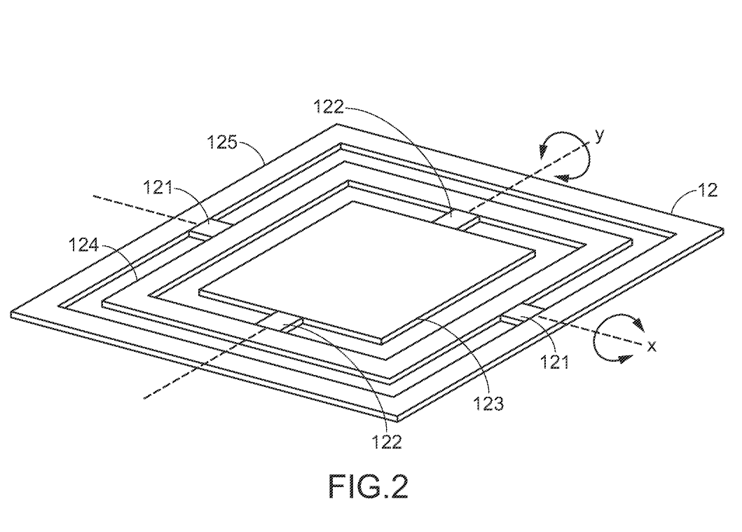

FIG. 2 is a schematic perspective view illustrating the detailed structure of an exemplary micro-electro-mechanical system mirror used in the camera device of the present invention. The MEMS mirror 12 is produced according to a semiconductor fabricating technology. The MEMS mirror 12 has a mirror body 123. For increasing reflectivity, a surface of the mirror body 123 is coated with a metallic material (e.g. aluminum) by a sputtering process. The mirror body 123 is connected with a middle frame 124 through a rotating shaft 122, so that the mirror body 123 is rotatable about the y axis. Similarly, the middle frame 124 is connected with an outer frame 125 through another rotating shaft 121, so that the middle frame 124 and the mirror body 123 are rotatable about the x axis. Due to change of magnetic field generated by the internal circuitry (not shown) of the MEMS mirror 12, the swinging frequency and the swinging angle of the mirror body 123 in the x-axis and y-axis directions are adjustable.

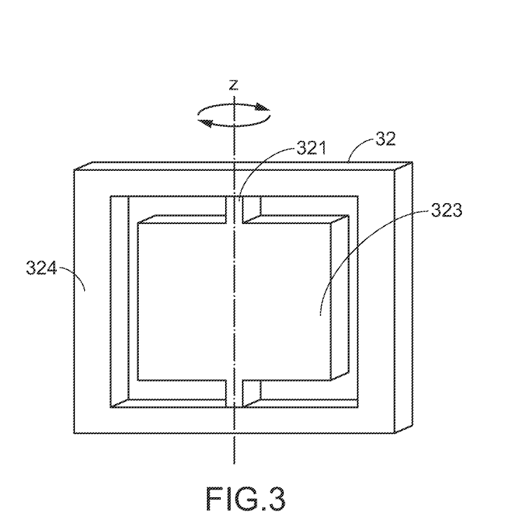

FIG. 3 is a schematic perspective view illustrating the detailed structure of another exemplary micro-electro-mechanical system mirror used in the camera device of the present invention. The MEMS mirror 32 of FIG. 3 is rotatable in a one-dimensional direction. The MEMS mirror 32 has a mirror body 323. The mirror body 323 is connected with an outer frame 324 through a rotating shaft 321, so that the mirror body 323 is rotatable about the z axis. When the one-dimensional MEMS mirror is used, the photo sensing element of the camera device is varied in order to capture a high-resolution image by using a low-pixel-number photo sensing element.

According to the optical imaging path as shown in FIG. 4, the light beam reflected by an object within the shooting region 6 is directed to the MEMS mirror 12 through the lens module 11. The light beam is reflected by the MEMS mirror 12 and then focused onto the photo sensing element 15 by the projection lens 14. The shooting region 6 is the region viewable through a viewfinder (e.g. a mechanical or electronic viewfinder, not shown) of the camera device 1. The shooting region 6 is divided into multiple shooting sub-regions 61. Each shooting sub-region 61 corresponds to the digital sub-image obtained for each exposure of the photo sensing element 15. Since the shooting sub-region 61 is smaller than the shooting region 6, a digital image having much higher pixel number than the photo sensing element 15 is obtainable by swinging the MEMS mirror 12 at multiple different angles and using a multiple exposure process. Once the button 131 of the shutter 13 is depressed, the MEMS mirror 12 is swung at multiple different angles corresponding to the shooting sub-region 61. When the MEMS mirror 12 is swung at a specified angle corresponding to a specified shooting sub-region 61, an exposure action of the photo sensing element 15 is performed to obtain a corresponding digital sub-image. Next, the MEMS mirror 12 is swung at another angle and another exposure action of the photo sensing element 15 is performed to obtain another digital sub-image. The above steps are repeatedly done until all shooting sub-regions 61 of the shooting region 6 have been exposed. Afterwards, these digital sub-images are combined together, thereby obtaining a high resolution digital image.

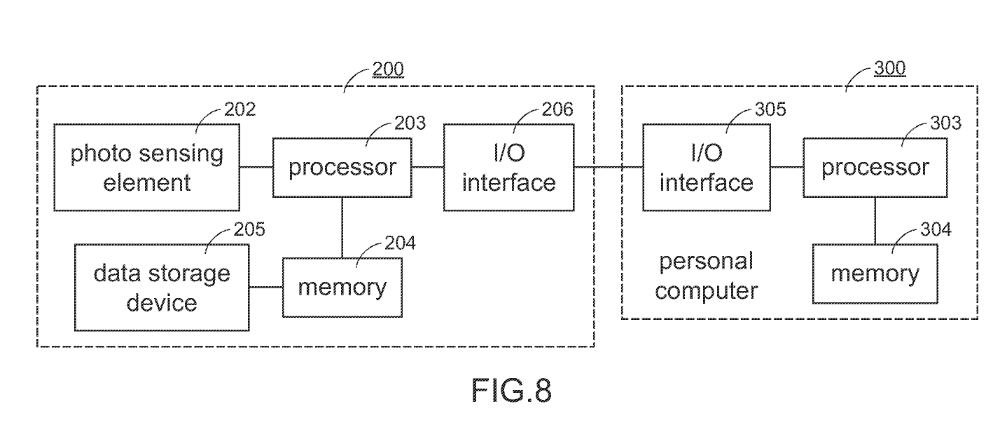

The task for combining the digital sub-images is implemented by a processor. The processor is a built-in processor of the camera device or an external processor (e.g. a processor of a personal computer). FIG. 8 is a schematic functional block diagram illustrating an image capturing system for capturing and combining digital sub-images according to the present invention. For clarification and brevity, the lens module, shutter button and the MEMS mirror included in the image capturing system are omitted. The camera device 200 includes a photo sensing element 202, a processor 203, a memory 204 and a data storage device 205. The image capturing system 200 could communicate with a personal computer 300 through input/out interfaces (I/O interfaces) 206 and 305. The personal computer 300 includes a processor 303 and a memory 304. Examples of the I/O interfaces 206 and 305 are USB (universal serial bus) interfaces or other interfaces. In a case that the processor 203 of the camera device 200 is used for combining the digital sub-images, the camera device 200 is considered as an image capturing system. In views of cost-effectiveness, the task for combining the digital sub-images is implemented by the processor 303 of the personal computer 300, and thus the camera device 200 and the personal computer 300 are collectively defined as the image capturing system. An example of the processor 303 is a central processing unit 303 of the personal computer 300. When the processor 303 of the personal computer 300 is used to combine the digital sub-images, it is no need to choose a high-end process as the processor 203 of the camera device 200, and thus the cost is reduced. The digital sub-images could be temporarily stored in the memory 204 or the data storage device 205 of the camera device 200 or the memory 304 of the personal computer 300. For combining the digital sub-images, the digital sub-images stored in the memory 204, the data storage device 205 or the memory 304 are read from the processor 203 or 303.

In a case that the data storage device 205 is for example a memory card removable from the casing 16 (see FIG. 1), the camera device 200 does not need to communicate with the personal computer 300 directly. After the digital sub-images are stored in the data storage device 205, the data storage device 205 is connected to and read out by the personal computer 300 through the I/O interface 305 or another interface. After the digital sub-images are combined as the digital image, the digital image could be stored in the data storage device 205 or the memory 304 or other data storage unit (not shown) of the personal computer 300.

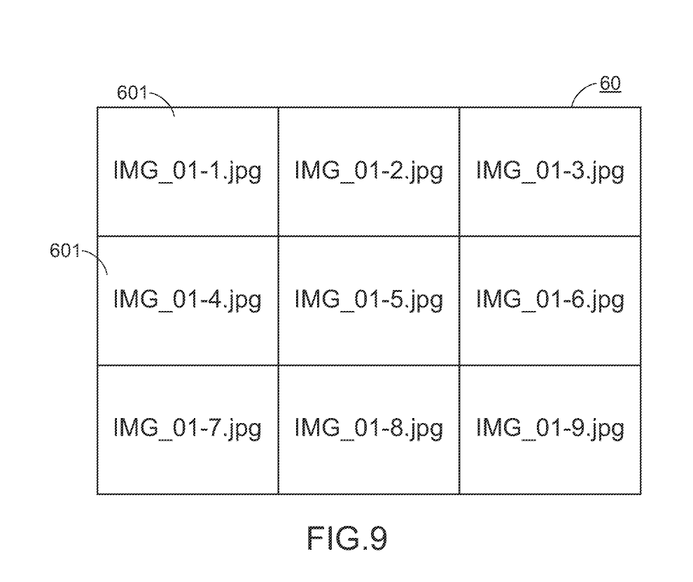

FIG. 9 is a schematic view illustrating a digital image obtained by the image capturing system of the present invention. As shown in FIG. 9, the digital image 60 is constituted by nine digital sub-images 601. Once the button of shutter is depressed, the nine digital sub-images 601 will be successively formed on the photo sensing element 202 by a multiple exposure process. Then, these digital sub-images 601 are successively stored in the data storage device 205.

As known, the current digital device could utilize firmware to control the filename format of the digital image. In other words, these nine digital sub-images 601 are successively stored as the filenames IMG_{—}01-1.jpg, IMG_{—}01-2.jpg, . . . , IMG_{—}01-9.jpg. According to the encoding sequence and the geometric relations between these digital sub-images 601, these nine digital sub-images 601 are combined as the digital image 60, which is stored as the filename IMG_{—}01.jpg.

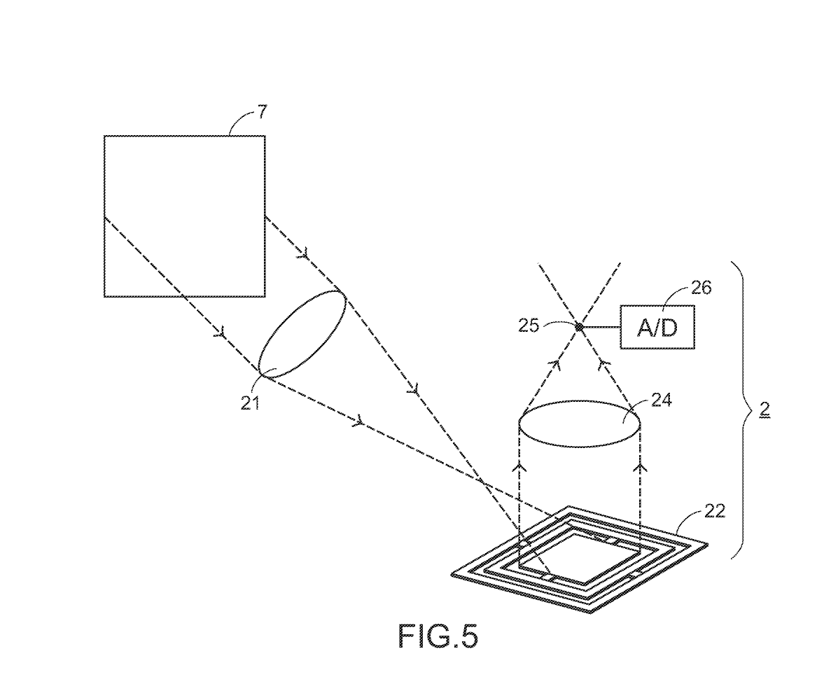

In the above embodiments, the photo sensing element is illustrated by referring to a CMOS chip or a CCD chip having multiple pixel sensors arranged in a two-dimensional array. Nevertheless, other photo sensing element could be applied to the camera device of the present invention. FIG. 5 is a schematic view illustrating an optical imaging path according to a second embodiment of the present invention. According to the optical imaging path as shown in FIG. 5, the light beam reflected by an object within the shooting region 7 is directed to the MEMS mirror 22 of the camera device 2 through the lens module 21. The MEMS mirror 22 is rotatable in the two-dimensional directions. The light beam is reflected by the MEMS mirror 22 and then focused onto the photo sensing element 25 by the projection lens 24. As shown in FIG. 4, the photo sensing element 15 has multiple pixel sensors 151 (e.g. photo diodes) to sense the optical image of the light beam. Whereas, in the embodiment as shown in FIG. 5, the photo sensing element 25 includes a single photo diode. By swinging the MEMS mirror 22 at different angles to reflect the light beam from the object within the shooting region 7, the light beam reflected by the MEMS mirror 22 is completely focused onto the photo sensing element 25 by the projection lens 24, thereby obtaining an analog signal. By an analog-to-digital converter (A/D) 26, the analog signal is converted into a digital signal and then formed as the digital signal. Since the photo sensing element having a single photo diode is relatively cost-effective, such a photo sensing element could be used in the low-level digital device in order to further reduce the fabricating cost.

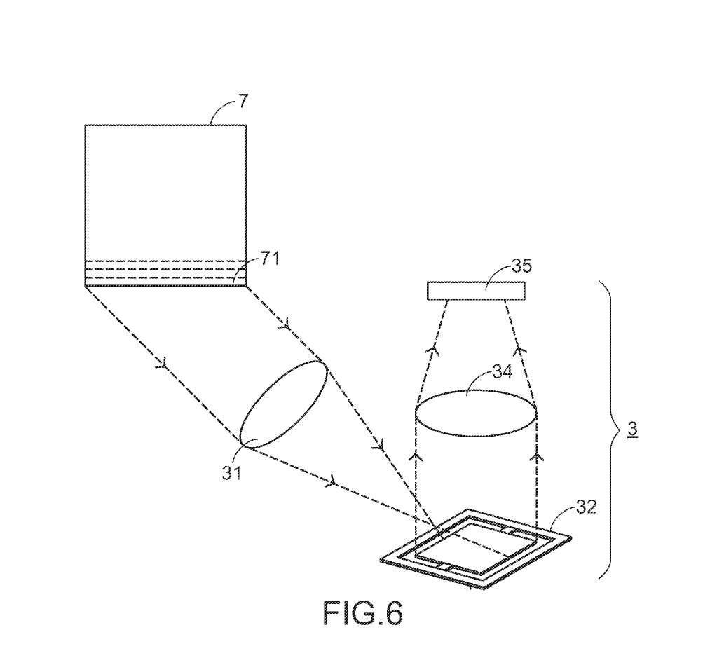

FIG. 6 is a schematic view illustrating an optical imaging path according to a third embodiment of the present invention. According to the optical imaging path as shown in FIG. 6, the light beam reflected by an object within the shooting region 7 is directed to the MEMS mirror 32 of the camera device 3 through the lens module 31. The light beam is reflected by the MEMS mirror 32 and then focused onto the photo sensing element 35 by the projection lens 34. In comparison with the above embodiments, the photo sensing element 35 is a linear photo sensing element including multiple photo diodes, which are arranged in a one-dimensional array. When the linear photo sensing element is used, the MEMS mirror 32 could be a one-dimensional MEMS mirror produced by a semiconductor fabricating technology. For each exposure of the photo sensing element 35, a strap digital sub-image corresponding to a shooting sub-region 71 is obtained. The strap digital sub-images obtained for all exposure actions are combined as the complete digital image corresponding to the shooting region 7.

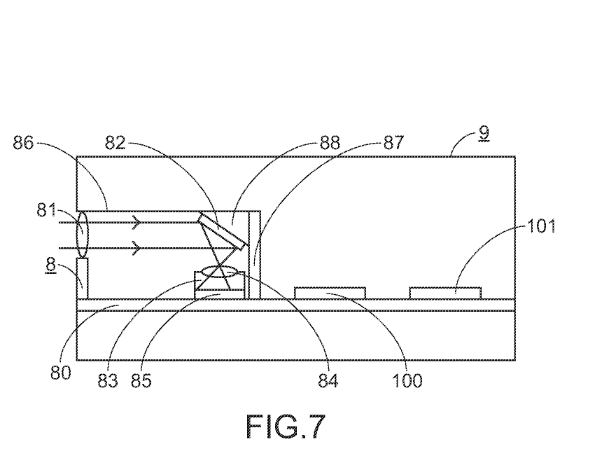

Recently, the general trends in designing a hand-held electronic device are toward small size, light weightiness and easy portability. The concept of the present invention could be applied to a camera module of a hand-held electronic device. FIG. 7 is a schematic cross-sectional view illustrating a camera module 8 of a hand-held electronic device 9. An example of the hand-held electronic device 9 includes but is not limited to a mobile phone, a personal digital assistant, a notebook computer or any portable device having an image pickup function. The camera module 8 comprises a printed circuit board 80, a casing 86, a photo sensing element 85, a reflective mirror 82, a first lens 81 and a second lens 84. The components of the camera module of the conventional hand-held electronic device are arranged in a stacked form. That is, the printed circuit board, the lens holder and the lens module of the conventional hand-held electronic device are successively stacked. Since the camera module 8 of the present invention has the reflective mirror 82 to adjust the optical path, the configuration and the arrangement of the components should be adjusted accordingly. As shown in FIG. 7, the photo sensing element 85 is mounted on the printed circuit board 80. The lens holder 83 is arranged on the photo sensing element 85. For clarification and brevity, as shown in FIG. 7, the lens holder 83 and the photo sensing element 85 are aligned with each other. In practice, the basal area of lens holder 83 is greater than the area of the photo sensing element 85. As such, the photo sensing element 85 is fixed on the lens holder 83 and the lens holder 83 is fixed on the photo sensing element 85. The reflective mirror 82 could be swung in a one-dimensional direction or a two-dimensional direction. An example of the reflective mirror 82 is a MEMS mirror. The reflective mirror 82 is not restricted to the MEMS mirror as long as the reflective mirror could be swung at different angles to increase the shooting region of the camera module 8 and allowed to perform a multiple exposure process to obtain a digital image having higher pixel number than the photo sensing element 85. In addition, the reflective mirror 82 is fixed on an inclined fixing element 88. A support post 87 is protruded from a surface of the printed circuit board 80 for supporting the inclined fixing element 88. In addition to the supporting function, a conducting wire (not shown) is disposed on the support post 87 for connecting the printed circuit board 80 and the reflective mirror 82. Via the conducting wire, electricity and control signals are transmitted from the printed circuit board 80 to the reflective mirror 82 in order to control the swinging operation of the reflective mirror 82. The first lens 81 is fixed on the casing 86. Generally, the lens module of a conventional camera module comprises several lenses of different functions and the lens module is fixed on the printed circuit board through a fixing element. Whereas, the camera module 8 of the present invention has the reflective mirror 82 to change the optical path. As shown in FIG. 9, the second lens 84 beside the photo sensing element 85 is also fixed on the printed circuit board 80 through the lens holder 83. Depending on the arrangement, size and overall configuration, the positions and fixing means of the reflective mirror 82 and the first lens 81 are variable.

The components of the camera module 8 could be completely enclosed by the casing 86. Alternatively, the casing 86 could be integrated with the printed circuit board 80, the support post 87 and the casing of the hand-held electronic device 9. In addition to the function of supporting the components of the camera module 8, the casing 86 could provide the light-shielding function to shield the optical imaging path of the camera module 8. In other words, the casing 86 could prevent the optical imaging path of the camera module 8 from being interfered by the external light beams that are not introduced into the camera module 8 through the first lens 81. In some embodiments, the casing 86 could be integrated with the printed circuit board 80, the support post 87 and a portion of the casing of the hand-held electronic device 9, thereby collectively forming a light-shielding structure. For example, a protrusion (not shown) could be extended from the printed circuit board 80 to fix the reflective mirror 82 and the first lens 81, and then a black celluloid sheet is used to fill the vacancy portions between the components to achieve a light-shielding purpose.

From the above description, the present invention provides a camera device, an image capturing system and a camera module. By using the reflective mirror to change the exposure angles and performing multiple exposure actions of the photo sensing element, a digital image having higher pixel number than the photo sensing element is obtained. That is, the camera device of the present invention is capable of capturing a high-resolution image by using a low-pixel-number photo sensing element. Even if the light-gathering area of each pixel for a small-size camera device is insufficient, the present invention can be applied to produce high resolution camera device without largely increasing the fabricating cost thereof.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A camera device comprising:
a lens module for receiving an external light beam;
a photo sensing element comprising at least one pixel sensor with a first pixel number; and
a micro-electro-mechanical system mirror for reflecting said external light beam to said photo sensing element, thereby obtaining a digital image with a second pixel number, wherein said micro-electro-mechanical system mirror is swung at different angles to receive said external light beam with different incidence angles, so that said second pixel number is higher than said first pixel number.

2. The camera device according to claim 1 wherein said micro-electro-mechanical system mirror includes a first rotating shaft, so that said micro-electro-mechanical system mirror is permitted to swing in a one-dimensional direction.

3. The camera device according to claim 2 wherein said photo sensing element is a linear photo sensing element.

4. The camera device according to claim 2 wherein said micro-electro-mechanical system mirror further includes a second rotating shaft, so that said micro-electro-mechanical system mirror is permitted to swing in a two-dimensional direction.

5. The camera device according to claim 4 wherein said at least one pixel sensor is a photo diode.

6. The camera device according to claim 4 wherein said at least one pixel sensor includes multiple pixel sensors, which are arranged in a two-dimensional array.

7. The camera device according to claim 6 wherein said multiple pixel sensors are formed on a chip.

8. The camera device according to claim 1 wherein said camera device is a hand-held camera device.

9. The camera device according to claim 8 wherein said external light beam is transmitted along an optical path to said photo sensing element through said lens module and said micro-electro-mechanical system mirror, and said camera device further comprises a light-shielding structure for enclosing said optical path, thereby preventing other light beam from entering said photo sensing element.

10. An image capturing system for processing an image of an object within a shooting region into a digital image, said image capturing system comprising:
a lens module for receiving a light beam from said object;
a photo sensing element comprising multiple pixel sensors, which are arranged in a two-dimensional array, for receiving said light beam and converting said light beam into an electronic signal, wherein an object region allowed to be processed during a single exposure duration of said photo sensing element is smaller than said shooting region;
a reflective mirror rotated in a two-dimensional direction for successively projecting said image of said object onto said photo sensing element by multiple times, so that said image of said object is converted into multiple digital sub-images; and
a processor for combining said multiple digital sub-images as said digital image.

11. The image capturing system according to claim 10 wherein said reflective mirror is a micro-electro-mechanical system mirror.

12. The image capturing system according to claim 11 wherein said reflective mirror includes two rotating shafts, which are rotated in two different directions.

13. The image capturing system according to claim 10 further comprising a casing for accommodating said lens module, said photo sensing element and said reflective mirror.

14. The image capturing system according to claim 13 wherein said processor is further accommodated within said casing.

15. The image capturing system according to claim 14 further comprising a data storage device for storing said digital image.

16. The image capturing system according to claim 15 further comprising a memory for temporarily storing said multiple digital sub-images.

17. The image capturing system according to claim 15 wherein said data storage device is removable from said casing.

18. The image capturing system according to claim 13 further comprising a personal computer, wherein said processor is a central processing unit of said personal computer.

19. The image capturing system according to claim 10 further comprising a shutter arranged between said lens module and said photo sensing element, wherein the light exposure duration of said photo sensing element is adjustable by controlling the open or close status of said shutter, and said multiple digital sub-images are formed during each cycle of opening and closing said shutter.

20. A camera module of a hand-held electronic device, said camera module comprising:
at least one photo diode pixel sensor;
a first lens for receiving an external light beam; and
a micro-electro-mechanical system mirror for reflecting said external light beam to said at least one photo diode pixel sensor, wherein said micro-electro-mechanical system mirror is swung at different angles so as to form a digital image.

21. The camera module according to claim 20 wherein said micro-electro-mechanical system mirror includes two rotating shafts rotated in two different directions, so that said micro-electro-mechanical system mirror is permitted to swing in a two-dimensional direction.

22. The camera module according to claim 21 wherein said at least one photo diode pixel sensor includes a single photo diode.

23. The camera module according to claim 21 wherein said at least one photo diode pixel sensor includes multiple photo diodes, which are formed on a chip and arranged in a two-dimensional array.

24. The camera module according to claim 20 wherein said at least one photo diode pixel sensor includes multiple photo diodes arranged in a line, and said micro-electro-mechanical system mirror includes a rotating shaft, so that said micro-electro-mechanical system mirror is permitted to swing in a one-dimensional direction.

25. The camera module according to claim 20 further comprising a second lens arranged between said micro-electro-mechanical system mirror and said at least one photo diode pixel sensor for adjusting said external light beam that is reflected by said micro-electro-mechanical system mirror.

26. The camera module according to claim 25 further comprising:
a printed circuit board for fixing said at least one photo diode pixel sensor; and
a lens holder mounted on said printed circuit board for fixing said second lens.

27. The camera module according to claim 26 further comprising a casing for enclosing and fixing said first lens, said micro-electro-mechanical system mirror and said printed circuit board.
